(19) United States
(12) Patent Application Publication
(10) Pub. No.: US 2012/0043186 A1
(43) Pub. Date: Feb. 23, 2012

(54) CONVEYOR BELT FOR A BELT CONVEYING SYSTEM

(75) Inventor: HERBERT TRIEB, LOCHAU (AT)

(73) Assignee: INNOVA PATENT GMBH, WOLFURT (AT)

(21) Appl. No.: 13/166,390

(22) Filed: Jun. 22, 2011

(30) Foreign Application Priority Data
Aug. 23, 2010 (AT) A 1407/2010

(51) Int. Cl. B65G 15/34

(52) U.S. Cl. 198/847

(57) ABSTRACT

A conveyor belt for a belt conveying system is formed of rubber or a rubber-like plastics material and reinforced by steel cables that extend in the longitudinal direction of the conveyor belt and run parallel to one another. The conveyor belt is assembled from interconnected portions. The steel cables, which have an inner cable core and helically encircling strands are arranged in the end regions of the portions such that they butt against one another, on the one hand, and overlap one another, on the other hand. The ends of groups of the steel cables are spaced apart from one another in the longitudinal direction of the conveyor belt. At least in the case of the majority of the steel cables, the strands, which enclose the cable core of the individual steel cables, terminate at different spacing distances from the ends of the cable core, as a result of which the cross sections of the steel cables decrease in the direction of the ends thereof.

### CROSS-REFERENCE TO RELATED APPLICATION

This application claims the priority, under 35 U.S.C. §119, of Austrian patent application A 1407/2010, filed Aug. 23, 2010; the prior application is herewith incorporated by reference in its entirety.

### BACKGROUND OF THE INVENTION

### Field of the Invention

The present invention relates to a conveyor belt for a belt conveying system. The conveyor belt is produced from rubber or a rubber-like plastics material and is reinforced by steel cables which extend in the longitudinal direction of the belt and run at least more or less parallel to one another. The conveyor belt is produced from interconnected portions and the steel cables, which comprise an inner cable core and strands enclosing the same helically, are arranged in the end regions of the portions such that they butt against one another, on the one hand, and overlap one another, on the other hand, and wherein, furthermore, the ends of groups of the steel cables are spaced apart from one another in the longitudinal direction of the conveyor belt.

Since belt conveying systems may be of any desired lengths, this also applies to the conveyor belts located therein. However, it is possible for conveyor belts, in particular also because they are designed with reinforcements comprising steel cables, to be produced and transported only in limited lengths on account of their great weight. There is therefore a need for the conveyor belts which are necessary for belt conveying systems to be produced in portions, for these portions to be transported to the location at which the belt conveying system is erected, and for the individual portions to be connected there to form a continuous conveyor belt.

The individual portions of the conveyor belts are connected in that the steel cables located in the conveyor belts are exposed at the successive ends of the portions, in that the ends of a first number of the steel cables of the successive portions are joined to one another, wherein they continue one another and butt against one another, and in that the end regions of a second number of the steel cables are arranged one beside the other, wherein the end regions of the second number of the steel cables of successive portions overlap. As a result, the two successive portions of the conveyor belt are connected by virtue of rubber plates and rubber material being vulcanized thereon.

In order to ensure the necessary dynamic tensile strength of a conveyor belt produced from portions, it is known for the steel cables to be subdivided, in the regions of the connection between two portions, into a number of groups of which the ends are spaced apart from one another. For example, the steel cables are thus subdivided into three groups with ends spaced apart from one another in the longitudinal direction. The steel cables of two groups which terminate at more or less equal spacings from one another in the longitudinal direction of the conveyor belt are continued by abutting steel cables, and these steel cables have further steel cables provided laterally alongside them, these further steel cables extending beyond the points of abutment and, rather than being continued by abutting steel cables, overlapping with the end regions of adjacent steel cables. Such a connecting method is referred to as being in three stages. In the case of a plurality of abutment points being offset in relation to one another in the longitudinal direction of the conveyor belt, such a connection is referred to as being in a number of stages.

This known connection between portions of a conveyor belt, however, does not meet operational requirements since, on account of end regions of the steel cables overlapping, the conveyor belt is subject to very high shearing stress, which is increased in that in these regions, in relation to the other regions, the proportion of steel reinforcement is increased and the proportion of rubber material is decreased, for which reason the elasticity of the conveyor belt, and therefore the dynamic tensile strength thereof, is reduced in these regions. It is therefore in these regions of the conveyor belt that the first cracks and rupturing occur during operation.

### SUMMARY OF THE INVENTION

It is accordingly an object of the invention to provide a conveyor belt, which overcomes the above-mentioned disadvantages of the heretofore-known devices and methods of this general type and which provides for a belt with an increased elasticity in the region of the ends of interconnected portions.

With the foregoing and other objects in view there is provided, in accordance with the invention, a conveyor belt for a belt conveying system, comprising:
a plurality of interconnected portions together forming the conveyor belt, the portions being formed with a belt body of rubber or plastics material and a plurality of reinforcing steel cables;
the steel cables extending in a longitudinal direction of the conveyor belt and substantially parallel to one another, the steel cables having an inner cable core and strands helically encircling the cable core;
the steel cables projecting with ends from end regions of the portions, with some of the steel cables abutting against one another and some of the steel cables overlapping one another;
wherein, at least in a majority of the steel cables, the helically encircling strands of individual the steel cables, terminating at different spacing distances from ends of the cable core, and wherein cross sections of the steel cables decrease in a direction of the ends thereof.

The ends of groups of the steel cables are spaced apart from one another in the longitudinal direction of the conveyor belt.

In other words, the objects of the invention are achieved in that, at least in the case of the majority of the steel cables, the strands, which enclose the cable core of the individual steel cables, terminate at different spacings from the end of the cable core, as a result of which the cross sections of the steel cables decrease in the direction of the ends thereof.

That is, the proportion of steel reinforcement is reduced and the proportion of rubber or of rubber-like material is increased in the interconnection region.

The ends of groups of the steel cables are preferably spaced apart at least more or less equally from one another in the longitudinal direction of the conveyor belt, wherein groups of approximately 10% to approximately 50% of the steel cables terminate at least more or less in the same cross sections of the conveyor belt.

Approximately 50% to approximately 90% of the steel cables are preferably continued by abutting steel cables, and approximately 50% to 10% of the steel cables are preferably of such lengths that the end regions of adjacent steel cables overlap, wherein they are not continued by abutting steel cables. Furthermore, it is possible for the individual steel cables of a group to have ends located more or less in a cross section of the conveyor belt distributed at least more or less regularly over the width of the conveyor belt.

In accordance with a further preferred embodiment of the invention, the ends of groups of the strands, which enclose a cable core, are spaced apart at least more or less equally from one another. Furthermore, groups of approximately 10% to approximately 30% of the strands, which enclose a cable core, may terminate at least more or less in the same cross sections of the cable core. In addition, preferably the individual groups of the strands which terminate more or less in the same cross sections of the cable core are distributed at least more or less regularly over the circumference of the cable core.

Furthermore, preferably the ends of the individual strands or groups of strands are present from one another at spacing distances that correspond to half the diameter of the steel cables up to ten times the diameter of the steel cables.

Other features which are considered as characteristic for the invention are set forth in the appended claims.

Although the invention is illustrated and described herein as embodied in a conveyor belt for a belt conveying system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective and schematic illustration of a conveyor belt according to the invention;

FIG. 2 is a perspective view of the joined-together ends of two portions of the conveyor belt according to FIG. 1;

FIG. 3 is a similar perspective view of a partial detail of the conveyor belt of FIG. 2, illustrated on an enlarged scale relative to FIG. 2;

FIGS. 4 and 4A are perspective views of an end region of a steel cable according to the invention; and

FIG. 5 is a perspective view, illustrated on an enlarged scale relative to FIG. 2, of a detail of the conveyor belt according to FIG. 2 with steel cables according to the invention.

### DETAILED DESCRIPTION OF THE INVENTION

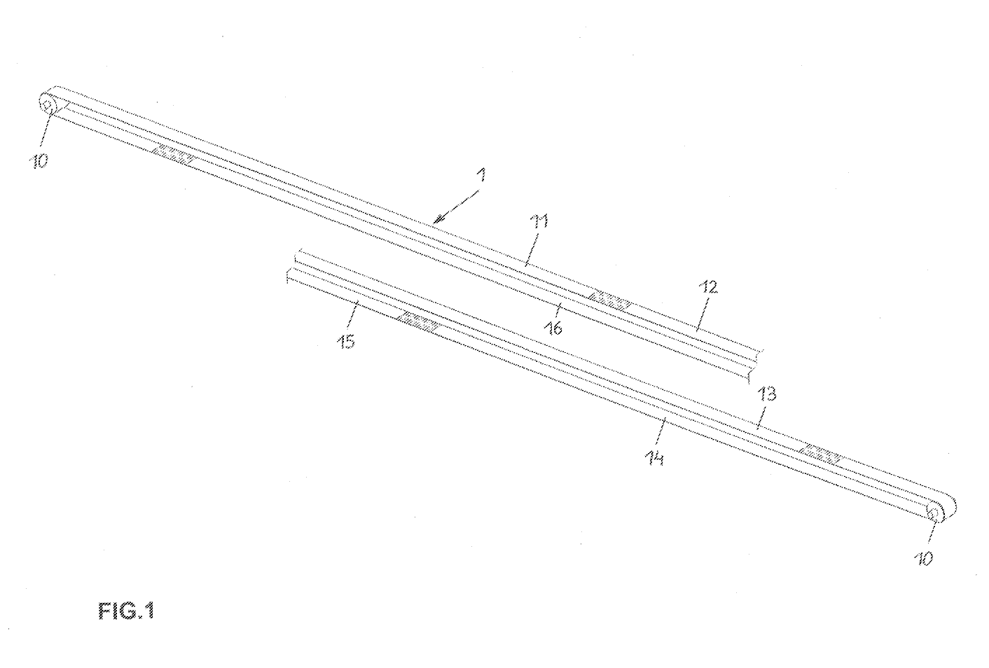

Referring now to the figures of the drawing in detail and first, particularly, to FIG. 1 thereof, there is shown a conveying system with a conveyor belt 1. The belt is a continuous, endless belt, with is guided via reversing drums 10, also referred to as deflecting drums 10 at the ends of the conveying system. The conveyor belt 1 of such conveying systems, which can extend, for example, over 15 km to 20 km, comprises a multiplicity of portions 11 to 16 which are connected to one another at their ends. The individual portions may be of lengths of from 200 m to 1000 m. The width of the conveyor belt 1 is between 0.4 m and 3.5 m. The conveyor belt 1 has a basic belt body consisting of rubber or a rubber-like plastics material with a thickness of approximately 2 cm to approximately 5 cm. The belt 1 is reinforced by a multiplicity of steel cables that are disposed in the belt body one beside the other, extend in the longitudinal direction of the conveyor belt 1 and have diameters of, for example, 6 mm to 20 mm.

The steel cables have a cable core, comprising a multiplicity of wires, and strands, likewise comprising a multiplicity of wires and encasing the cable core helically.

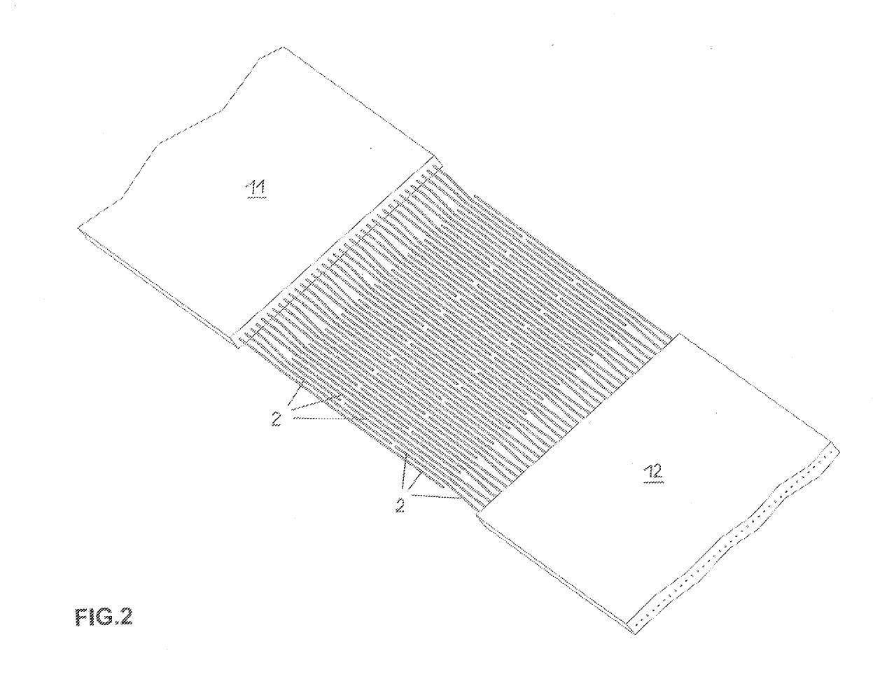

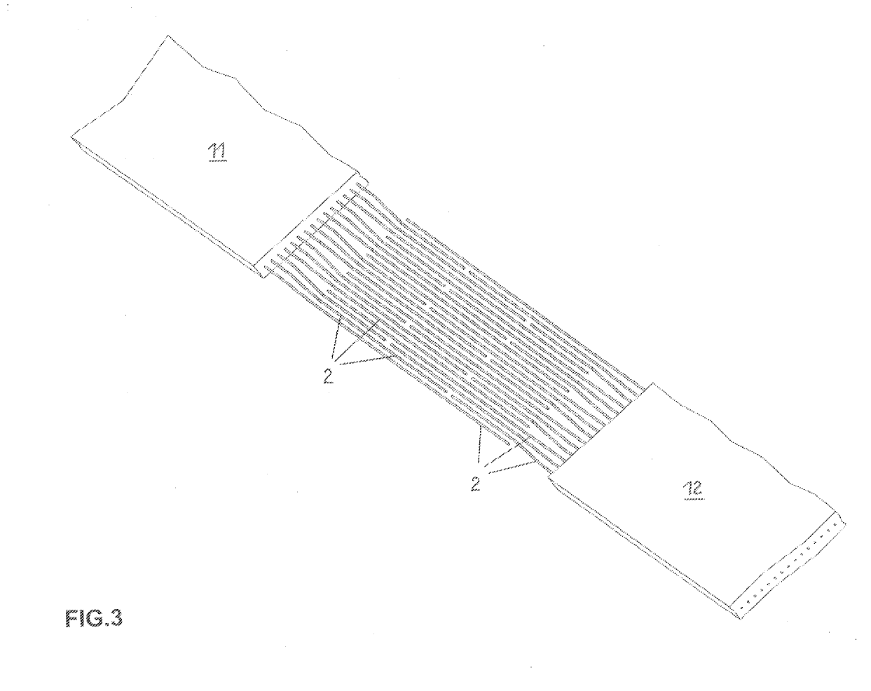

As is illustrated in FIGS. 2 and 3, the end regions of the steel cables 2 are exposed at the connecting locations between two portions 11 and 12, and these end regions are arranged such that they overlap one another, on the one hand, and butt against one another, and continue one another, on the other hand. It is possible here for the steel cables 2 to be subdivided into groups of which the ends are spaced apart from one another. Depending on the number of cross sections of the conveyor belt 1 in which the ends of the steel cables 2 are located, these connections are referred to as having one, two or three more stages.

A three-staged connection is illustrated in FIGS. 2 and 3.

In the case of prior art conveyor belts 1, in the regions of the connection between two portions 11 and 12, the overlapping of the end regions of the steel cables 2 means that the proportion of steel inserts in relation to the proportion of rubber or rubber-like material is significantly higher than in those regions of the conveyor belts 1 which are located between the connections, for which reason these conveyor belts 1 are significantly less elastic, and/or the dynamic tensile strength thereof is significantly lower, in the regions of the connections than is the case in the remaining regions.

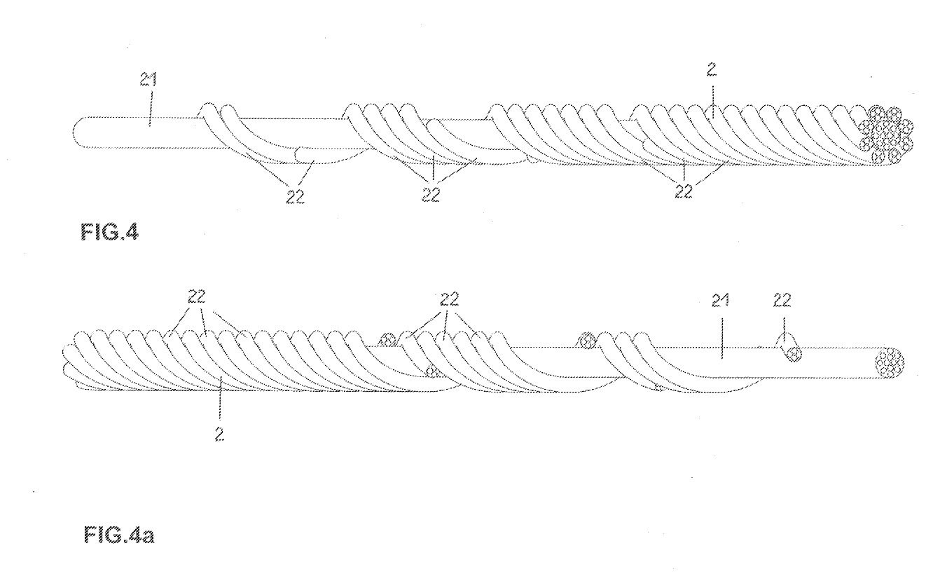

As is illustrated in FIGS. 4 and 4a, the steel cables 2 comprise a cable core 21, comprising a multiplicity of wires, and also a multiplicity of strands 22, likewise comprising a multiplicity of wires and enclosing the cable core 21 helically. According to the present invention, the individual strands 22 terminate at different spacings from the ends of the cable core 21. This means that, in the regions of the connection between two portions, the proportion of steel inserts is reduced and/or the proportion of rubber or elastomeric material is increased, and this increases the elasticity of the conveyor belt 1 in the regions of the connection between two portions. Furthermore, the shearing stress is reduced in these regions.

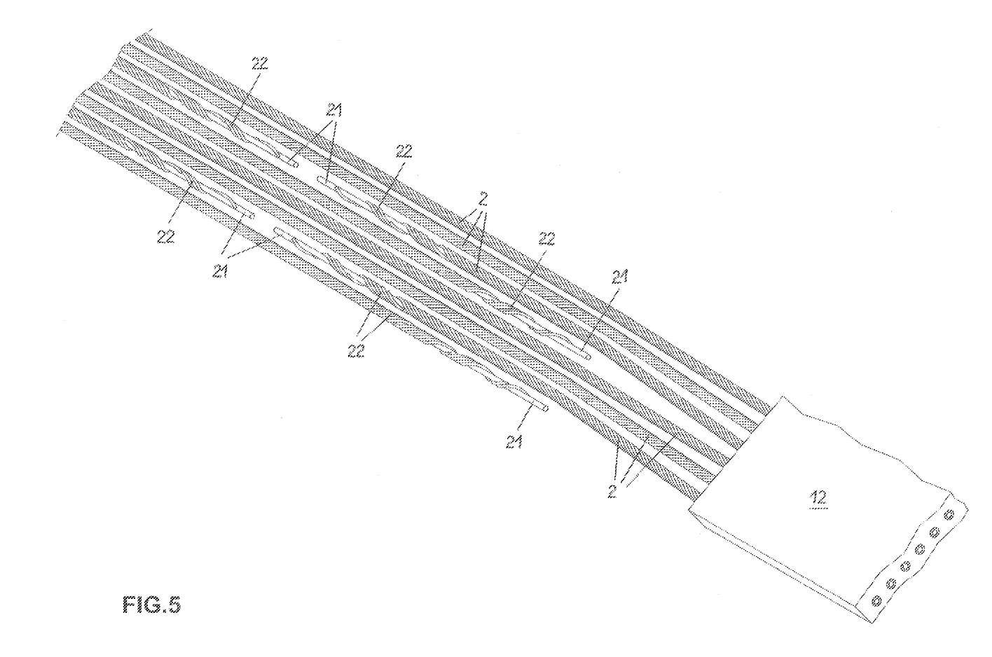

As can also be seen from FIG. 5, both the end regions of those steel cables 2 which are arranged such that they overlap one another and the end regions of those steel cables 2 which are arranged such that they butt against one another, and continue one another, have cross sections which decrease in the direction of the ends, as a result of the fact that the strands 22 terminate at different spacings from the ends of the cable cores 21.

The helically running strands 22 here may be combined into groups of which the ends terminate in the same cross sections of the steel cables 2, wherein the individual strands 22 of these groups may be located one beside the other or may be distributed over the circumference of the steel cables 2.

The effect according to the invention is also achieved when the ends of at least the majority of the steel cables 11 are designed with strands 22 which have been shortened to different extents according to the invention.

The spacing distances between the ends of the individual strands 22 or groups of strands 22, which surround the cable cores 21, have values between half the diameter of the steel cables 2 and ten times the diameter of the steel cables 2.

1. A conveyor belt for a belt conveying system, comprising:
a plurality of interconnected portions together forming the conveyor belt, said portions being formed with a belt body of rubber or plastics material and a plurality of reinforcing steel cables;
said steel cables extending in a longitudinal direction of the conveyor belt and substantially parallel to one another, said steel cables having an inner cable core and strands helically encircling said cable core;
said steel cables projecting with ends from end regions of said portions, with some of said steel cables abutting against one another and some of said steel cables overlapping one another;
wherein, at least in a majority of said steel cables, said helically encircling strands of individual said steel cables, terminating at different spacing distances from ends of said cable core, and wherein cross sections of said steel cables decrease in a direction of said ends thereof.

2. The conveyor belt according to claim 1, wherein said ends of groups of said steel cables are spaced apart from one another in the longitudinal direction of the conveyor belt.

3. The conveyor belt according to claim 1, wherein said ends of groups of said steel cables are spaced apart at least substantially equidistantly from one another in the longitudinal direction of the conveyor belt.

4. The conveyor belt according to claim 1, wherein groups of approximately 10% to 50% of said steel cables terminate substantially in a same cross section of the conveyor belt.

5. The conveyor belt according to claim 1, wherein approximately 50% to approximately 90% of said steel cables are continued by abutting steel cables, and wherein approximately 50% to 10% of said steel cables are of such lengths that the end regions of respectively adjacent said steel cables overlap, wherein said steel cables are not continued by abutting steel cables.

6. The conveyor belt according to claim 1, wherein individual said steel cables of a group have ends disposed more or less in one of the cross sections thereof distributed substantially regularly over a width of the conveyor belt.

7. The conveyor belt according to claim 1, wherein said ends of groups of said strands that encircle a cable core are spaced apart substantially equidistantly from one another.

8. The conveyor belt according to claim 1, wherein groups of approximately 10% to approximately 30% of said strands that encircle a cable core terminate substantially in a same cross sections of said cable core.

9. The conveyor belt according to claim 1, wherein individual groups of said strands that terminate substantially in the same cross sections of said cable core are distributed at least substantially regularly over a circumference of said cable core.

10. The conveyor belt according to claim 1, wherein the ends of the individual strands or groups of strands are spaced from one another at spacing distances corresponding to half a diameter of said steel cables and up to ten times the diameter of said steel cables.
